(19) United States
(12) Patent Application Publication
(10) Pub. No.: US 2011/0167415 A1
(43) Pub. Date: Jul. 7, 2011

(54) LANGUAGE PROCESSING APPARATUS, LANGUAGE PROCESSING METHOD, AND COMPUTER PROGRAM PRODUCT

(75) Inventor: Seiji HAYASHIDA, Kanagawa (JP)

(73) Assignee: KABUSHIKI KAISHA TOSHIBA, Tokyo (JP)

(21) Appl. No.: 12/716,649

(22) Filed: Mar. 3, 2010

(30) Foreign Application Priority Data
Jan. 6, 2010 (JP) 2010-001424

(51) Int. Cl. G06F 9/45

(52) U.S. Cl. 717/142; 717/143; 717/140

(57) ABSTRACT

A language processing apparatus comprises a first assembler file generating unit that allocates a variable included in a source program written in a single module to a register, generates an assembler code for each function, inserts a save-restore code for the register into an entry-exit point of a function that uses the register, and generates a first assembler program; and a second assembler file generating unit that, when the register used in the function is not used in a caller, migrates the save-restore code for the register written in the first assembler file to an entry-exit point of the caller, and generates a second assembler program.

### CROSS-REFERENCE TO RELATED APPLICATIONS

This application is based upon and claims the benefit of priority from the prior Japanese Patent Application No. 2010-001424, filed on Jan. 6, 2010; the entire contents of which are incorporated herein by reference.

### BACKGROUND OF THE INVENTION

1. Field of the Invention

The present invention relates to a language processing apparatus, a language processing method, and a computer program product.

2. Description of the Related Art

A compiler that generates an assembler code (assembler program) for a target processor from a source program written in a high-level language allocates a variable written in a source code to a register to be an operand of an instruction written in an assembly language. The register allocated to the variable by the compiler includes two types when a function call is made, that is, a register (non-volatile register) that ensures that the value does not change before and after the function call and a register in which the value may change before and after the function call. An application binary interface (ABI) defines a register to be the non-volatile register for each target processor.

The compiler includes one that has a function of generating a code (hereinafter, save-restore code) for saving/restoring register content at an entry-exit point of a function on the called side to ensure that the value of the register does not change before and after the function call when the non-volatile register is used in the function. The function on the side that calls the function is defined as a caller, and the function on the called side is defined as a callee.

On the other hand, in the target processor, because the execution of the save-restore code involves a memory access, the execution speed becomes fast as the number of executions of the save register is small. Therefore, the compiler is desired to optimize the assembler code so that the number of executions of the save register becomes small.

As a technology for optimizing the save-restore code, Japanese Patent Application Laid-open No. H11-272473 discloses a technology for deleting a corresponding save-restore code from the callee when it is possible to determine that the operation of the whole program as a target does not change even if the value of the non-volatile register is destroyed in the callee.

### BRIEF SUMMARY OF THE INVENTION

A language processing apparatus according to an embodiment of the present invention comprises:

a first assembler file generating unit that allocates a variable included in a source program written in a single module to a register, generates an assembler code for each function, inserts a save-restore code for the register into an entry-exit point of a function that uses the register, and generates a first assembler program; and

a second assembler file generating unit that, when the register used in the function is not used in a caller, migrates the save-restore code for the register written in the first assembler file to an entry-exit point of the caller, and generates a second assembler program.

A language processing method according to an embodiment of the present invention comprises:

performing a lexical and syntax analysis on a source program written in a single module;

generating function call information in which a call relation between functions included in the source program is written based on an execution result of the lexical and syntax analysis;

allocating a register to a variable included in the source program based on the execution result of the lexical and syntax analysis;

generating non-volatile register information on a non-volatile register in which a value does not change in the function included in the source program for each function based on an allocation result of the variable;

generating a first assembler program in which a save-restore code for protecting content of the non-volatile register is inserted into an entry-exit point of a function that uses the non-volatile register from the source program based on the allocation result of the variable;

determining whether the save-restore code is capable of being migrated from the function into which the save-restore code is inserted to a function as a call source of the function based on the function call information and the non-volatile register information and generating save-restore code information that indicates a function as a migration destination of the save-restore code; and

migrating the save-restore code written in the first assembler program based on the non-volatile register information and the save-restore code information and generating a second assembler program.

A computer program product according to an embodiment of the present invention includes a plurality of instructions executable on a computer, wherein the instructions, when executed by the computer, cause the computer to perform:

performing a lexical and syntax analysis on a source program written in a single module;

generating function call information in which a call relation between functions included in the source program is written based on an execution result of the lexical and syntax analysis;

allocating a register to a variable included in the source program based on the execution result of the lexical and syntax analysis;

generating non-volatile register information on a non-volatile register in which a value does not change in the function included in the source program for each function based on an allocation result of the variable;

generating a first assembler program in which a save-restore code for protecting content of the non-volatile register is inserted into an entry-exit point of a function that uses the non-volatile register from the source program based on the allocation result of the variable;

determining whether the save-restore code is capable of being migrated from the function into which the save-restore code is inserted to a function as a call source of the function based on the function call information and the non-volatile register information and generating save-restore code information that indicates a function as a migration destination of the save-restore code; and

migrating the save-restore code written in the first assembler program based on the non-volatile register information and the save-restore code information and generating a second assembler program.

### BRIEF DESCRIPTION OF THE DRAWINGS

FIG. 1 is a diagram explaining an example of a source code input to a compiling apparatus;

FIG. 2 is a diagram explaining examples of an assembler code generated from the source code;

FIG. 3 is a diagram illustrating a configuration of the compiling apparatus according to a first embodiment;

FIG. 4 is a diagram explaining a hardware configuration of the compiling apparatus according to the first embodiment;

FIGS. 5A and 5B are diagrams explaining an example of the source code and the assembler code generated from the source code;

FIG. 6 is a flowchart explaining a compiling method according to the first embodiment;

FIG. 7 is a diagram illustrating an example of function call information;

FIG. 8 is a diagram illustrating an example of non-volatile register information;

FIG. 9 is a flowchart explaining an operation of generating save-restore code information by a save-restore code information generating unit;

FIGS. 10A and 10B are diagrams illustrating examples of the save-restore code information;

FIG. 11 is a diagram illustrating an example of a second assembler code;

FIGS. 12-1A and 12-1B are diagrams for explaining a specific example when the save-restore codes for the same non-volatile register migrate to the same caller from a plurality of callees;

FIGS. 12-2C and 12-2D are diagrams for explaining a specific example when the save-restore codes for the same non-volatile register migrate to the same caller from a plurality of callees;

FIG. 13 is a diagram in which a first assembler code is compared with the second assembler code;

FIG. 14 is a diagram explaining another hardware configuration of the compiling apparatus according to the first embodiment;

FIG. 15 is a diagram explaining another hardware configuration of the compiling apparatus according to the first embodiment; and

FIG. 16 is a diagram illustrating a configuration of a compiling and assembling apparatus according to a second embodiment.

### DETAILED DESCRIPTION OF THE INVENTION

Exemplary embodiments of a language processing apparatus, a language processing method, and a computer program product according to the present invention will be explained below in detail with reference to the accompanying drawings. The present invention is not limited to the following embodiments.

A subroutine that returns a value is called a function and a subroutine that does not return a value is called a procedure depending on a programming language. In the embodiments of the present invention, the concept of the function also includes the procedure.

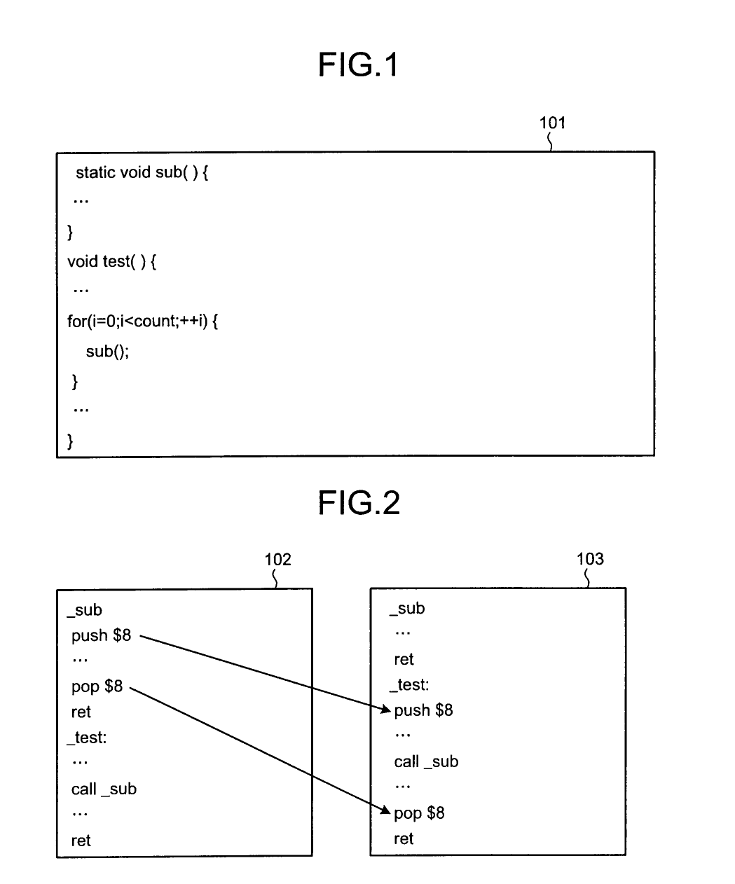

A first embodiment of the present invention is applied to a compiling apparatus (compiler) that converts a source program (source code) into an assembly language for each module to generate an assembler code (assembler program). The compiling apparatus in the first embodiment has a function (save-restore code generating function) of generating a save-restore code with respect to content of a non-volatile register at an entry-exit point of a callee when the non-volatile register is used in the callee. First, the characteristics of the first embodiment are explained with reference to FIG. 1 and FIG. 2.

FIG. 1 is a diagram illustrating an example of the source code input to the compiling apparatus in the first embodiment. In this example, a function sub and a function test are defined in a source code 101 written in C. The function test includes loop processing and the function sub is called in this loop processing.

The compiler in the first embodiment first generates an assembler code (first assembler code) from the source code 101 by using the save-restore code generating function. Then, the compiler corrects the first assembler code so that the number of executions of the save-restore code becomes small and generates an assembler code (second assembler code) as a final product in the first embodiment.

FIG. 2 is a diagram illustrating examples of the assembler code generated from the source code 101. In this example, an ABI for the target processor defines that a register “$8” is used as the non-volatile register.

An assembler code 102 is an example of the first assembler code generated from the source code 101. The compiler performs a register allocation so that $8 is used in the function sub and $8 is not used in the function test. As shown in the assembler code 102, an instruction “push $8” for saving content of $8 in a stack is written at the entry point of the function sub and an instruction “pop $8” for restoring the saved content to $8 is written at the exit point of the function sub for preventing the content from being destroyed by the use of $8. In the followings, such a pair of the push and the pop is called a save-restore code. Because $8 is not used in the function test, the save-restore code for $8 is not written in the function test. An instruction “call_sub” for calling the function sub is written in a block corresponding to the function test.

In the source code 101, the function sub is called in a for loop included in the function test. In other words, the “call_sub” and the function sub are repeatedly executed for the number of times satisfying the condition of the for loop. In the assembler code 102, the target processor executes saving/restoring of the content of $8 every time the function sub is called.

An assembler code 103 is an example of the second assembler code generated from the assembler code 102. As shown in FIG. 2, the save-restore code that is written at the entry-exit point of the function sub in the assembler code 102 is migrated to the entry-exit point of the function test that calls the function sub in the assembler code 103.

With the assembler code 103, the target processor saves the content of $8 at the entry point in the function test, then executes the loop, and restores the content of $8 at the exit point of the function. In this case, the number of executions of the save-restore code is once, different from the case of the assembler code 102 in which the number of executions of the save-restore code is the number of times of the loop in the function test.

In this manner, the first embodiment of the present invention is mainly characterized in that the assembler code in which the number of executions of the save-restore code is reduced can be generated by migrating the save-restore code for the non-volatile register written at the entry-exist point of the callee to the entry-exist point of the caller. The processing of migrating the save-restore code included in the first assembler code is called save-restore code migration processing.

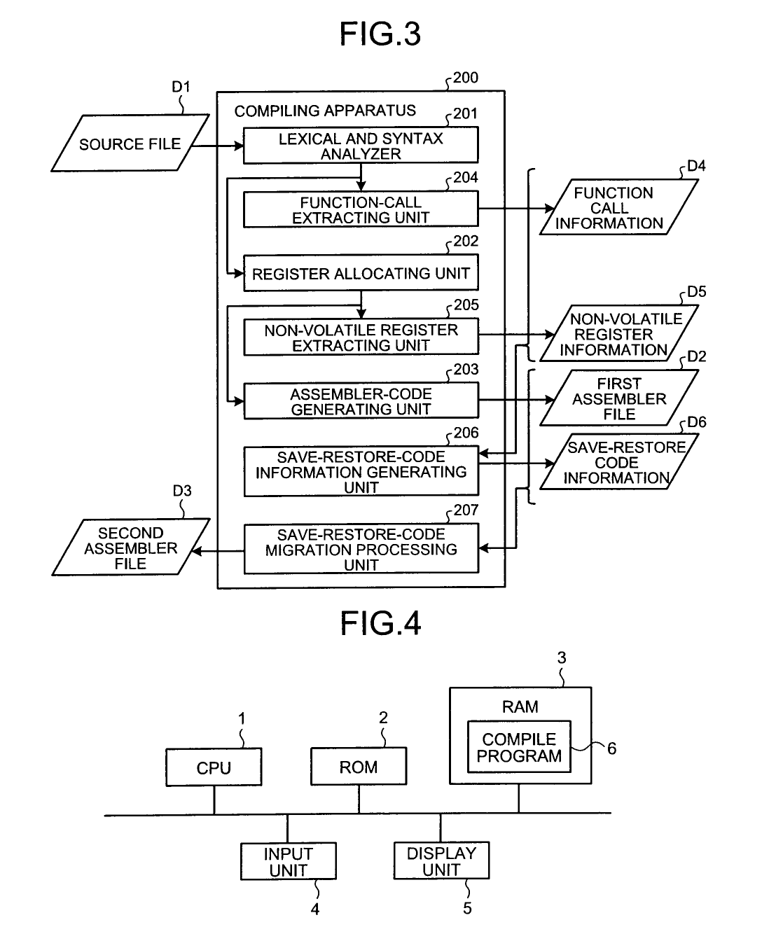

FIG. 3 is a configuration diagram of the compiling apparatus according to the first embodiment. A source file D1 that is a file of a module in which the source code is written is input to a compiling apparatus 200. The compiling apparatus 200 generates a first assembler file D2 that is a file in which the first assembler code is written based on the input source file D1. Then, the compiling apparatus 200 performs the save-restore code migration processing on the first assembler code and outputs a second assembler file D3 that is a file in which the second assembler code is written. The compiling apparatus 200 generates one second assembler file D3 from one source file D1.

The compiling apparatus 200 includes a lexical and syntax analyzer 201, a register allocating unit 202, and an assembler-code generating unit 203 as a configuration (first-assembler-file generating unit) for generating the first assembler file D2.

The functions of the lexical and syntax analyzer 201, the register allocating unit 202, and the assembler-code generating unit 203 are the same as the functions of the respective components included in a generally-available compiling apparatus. In the lexical analysis by the lexical and syntax analyzer 201, each character included in the input source file D1 is loaded into, for example, a RAM. Then, in the syntax analysis by the lexical and syntax analyzer 201, the meaning of each loaded character and the meaning (such as a function, a variable, and an assignment statement relation) on a program written in the source file D1 caused by the combination of characters are recognized.

The register allocating unit 202 allocates the register to each variable included in the source file D1 based on an analysis result by the lexical and syntax analyzer 201. The assembler-code generating unit 203 generates the assembler code based on a register allocation result by the register allocating unit 202 to generate the first assembler file D2. When the non-volatile register is allocated to the variable, the assembler-code generating unit 203 inserts the save-restore code for this non-volatile register into the entry-exit point of this function.

Furthermore, the compiling apparatus 200 includes a function-call extracting unit 204, a non-volatile register extracting unit 205, a save-restore code information generating unit 206, and a save-restore code migration processing unit 207 as a configuration (second-assembler-file generating unit) for generating the second assembler file D3 from the first assembler file D2.

The function-call extracting unit 204 extracts information on a call relation between functions included in the source file D1, information on whether each function is a function called from other modules, and information on whether there is a possibility of a dynamic call, based on the analysis result by the lexical and syntax analyzer 201. The function-call extracting unit 204 generates the extracted call relation as function call information D4.

The non-volatile register extracting unit 205 generates non-volatile register information D5 that is a list of the non-volatile register used in the function for each function based on the register allocation result by the register allocating unit 202.

The save-restore code information generating unit 206 determines whether the save-restore code for the non-volatile register used in the function can be migrated for each function based on the function call information D4 and the non-volatile register information D5. More specifically, when a target function uses the non-volatile register and there is no function that uses this non-volatile register among the callers that call this target function, the save-restore code information generating unit 206 determines that the save-restore code for this non-volatile register can be migrated. Moreover, the save-restore code information generating unit 206 generates save-restore code information D6 in which the position (i.e., the position into which the save-restore code is inserted by the assembler-code generating unit 203) of the save-restore code before the save-restore code migration processing and the position of the save-restore code after the save-restore code migration processing are written.

The save-restore code migration processing unit 207 performs the save-restore code migration processing on the save-restore code written in the first assembler file D2 based on the save-restore code information D6 to generate the second assembler file D3. The first assembler file D2 is not the final assembler code, so that the first assembler file D2 can be placed in a state of being stored in a memory as internal information without being output as a file.

FIG. 4 is a diagram illustrating a hardware configuration of the compiling apparatus 200. The compiling apparatus 200 has a computer configuration including a central processing unit (CPU) 1, a read only memory (ROM) 2, a random access memory (RAM) 3, an input unit 4, and a display unit 5. The respective units are connected with each other via a bus line or the like.

The CPU 1 executes a compile program 6 that is a computer program product that executes a compiling method in the first embodiment. The display unit 5 is a display device such as a liquid crystal monitor and displays output information for a user such as an operation screen based on an instruction from the CPU 1. The input unit 4 is configured to include a mouse, a keyboard, and the like, and inputs an operation from a user to the compiling apparatus 200. The operation information input from the input unit 4 is sent to the CPU 1 to be processed.

The compile program 6 has a module configuration including the lexical and syntax analyzer 201, the register allocating unit 202, the assembler-code generating unit 203, the function-call extracting unit 204, the non-volatile register extracting unit 205, the save-restore code information generating unit 206, and the save-restore code migration processing unit 207. These configuration units are generated in the RAM 3 by loading the compile program 6 into the RAM 3.

The compile program 6 is stored in the ROM 2 and is loaded into the RAM 3 via a bus line. FIG. 4 illustrates a state in which the compile program 6 is loaded into the RAM 3. The CPU 1 executes the compile program 6 loaded into the RAM 3. The CPU 1 executes various processing based on the source file D1 input from an external storage or the like, and temporarily stores intermediate data such as the first assembler file D2, the function call information D4, the non-volatile register information D5, and the save-restore code information D6 generated in the various processing in a data storage area formed in the RAM 3. The CPU 1 uses the data temporarily stored in the data storage area to generate the second assembler file D3 and outputs it to a program storage area in the RAM 3, the external storage, or the like. The compile program 6 can be stored in a storage device such as a disk or loaded.

The compile program 6 can be provided or distributed in such a way that the compile program 6 is stored in a computer connected to a network such as the Internet and is downloaded via the network. Alternatively, the compile program 6 can be incorporated in the ROM 2 or the like in advance and provided to the compiling apparatus 200

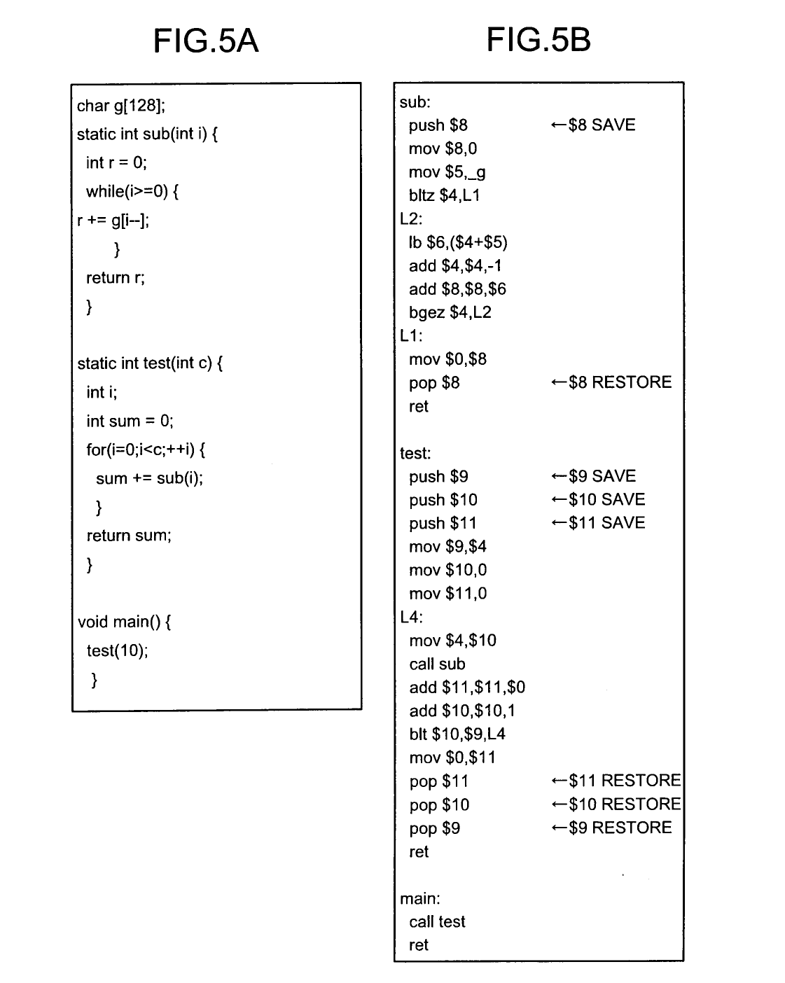

Next, the compiling method in the first embodiment of the present invention realized by using the compiling apparatus 200 is explained. The processor in which registers $8 to $11 are defined as the non-volatile register is set as the target processor. The source code (source file D1) shown in FIG. 5A is input. In the source code shown in FIG. 5A, the function sub, the function test, and the function main are written, the function main calls the function test, and the function test calls the function sub in the loop processing. The first assembler file D2 in which the first assembler code (FIG. 5B) is written is obtained from the source code (FIG. 5A) by the processing by the first-assembler-file generating unit. Moreover, according to the first assembler code shown in FIG. 5B, the save-restore code for $8 is generated at the entry-exit point of the function sub and the save-restore codes for $9 to $11 are generated at the entry-exit point of the function test. With this first assembler code, the save-restore code for $8 is executed every time the function test executes the loop processing.

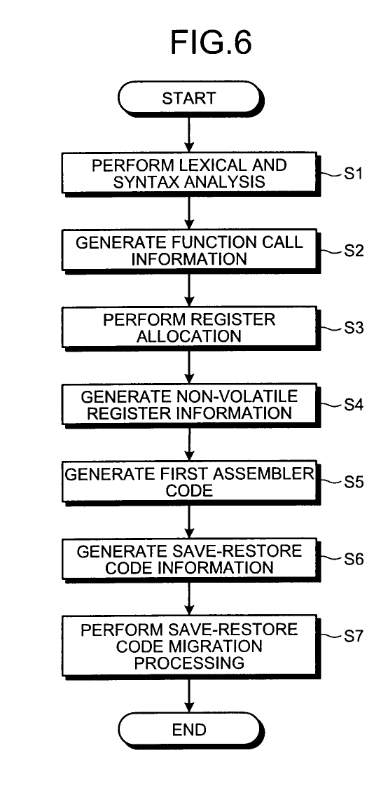

FIG. 6 is a flowchart explaining the compiling method according to the first embodiment. First, the lexical and syntax analyzer 201 performs the analysis of the source file D1 written in the source file D1 (S1). Then, the function-call extracting unit 204 extracts the information on the call relation between the functions, the information on whether each function is a function called from other modules, and the information on whether there is a possibility of the dynamic call based on the analysis result by the lexical and syntax analyzer 201, and generates the function call information D4 (S2).

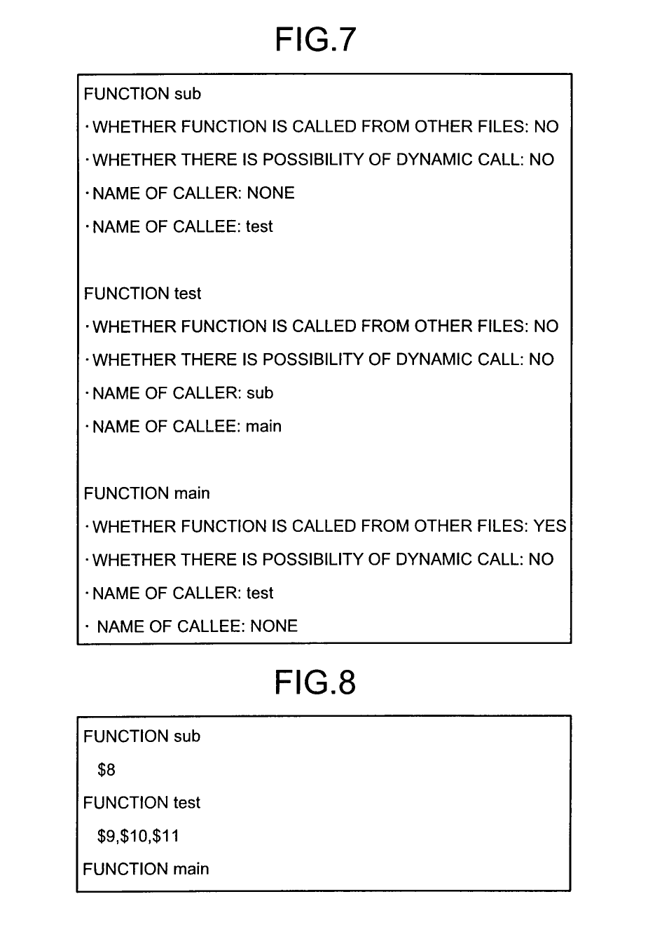

FIG. 7 is a diagram illustrating an example of the function call information D4. As shown in FIG. 7, the function call information D4 includes a field in which the callee that the function calls and the caller that calls the function are written for each function. For example, in the function test, the function sub is the callee and the function main is the caller.

The analysis by the lexical and syntax analyzer 201 is performed by the static analysis, so that the call in which a jump destination dynamically changes by the function call using a pointer of the function or the like cannot be analyzed. Therefore, in the first embodiment of the present invention, the save-restore code included in the function that may be called dynamically is not subjected to the save-restore code migration processing. Moreover, if the save-restore code migration processing is to be performed on the save-restore code included in the function that may be called from a module other than the input source file D1, all of the source modules constituting the program need to be analyzed, so that the processing of determining whether the save-restore code migration processing can be performed becomes complicated, and therefore the compile time becomes long. Thus, in the first embodiment of the present invention, the save-restore code included in the function that may be called from other modules is also not subjected to the save-restore code migration processing.

The function call information D4 includes a field in which whether the function is a function called from other modules different from the input source file D1 and whether the function may be called by the dynamic call are written for each function. Whether the function is a function called from other modules can be determined, for example, by determining whether the function is a function declared as static in the case of C. Moreover, in the case of C, an address of the function needs to be set to a pointer-type variable of the function by an initial value or an assignment statement for the dynamic call of the function. Therefore, when there is no reference to the callee other than the function call for the callee in the source file D1, it is possible to determine that the dynamic function call for the callee does not occur in the source file D1. In an example shown in FIG. 7, for example, the function call information D4 indicates that the function test is not a function to be called from other modules because the function test is declared as static and the function test is not called by the dynamic call because the function test is not referred to other than the call in the function main.

Next, the register allocating unit 202 allocates the register to the variable written in the source file D1 based on the analysis result by the lexical and syntax analyzer 201 (S3). In an example shown in FIG. 5B, $4 and $8 are allocated to a variable i and a variable r, respectively, in the function sub, and $9, $10, and $11 are allocated to a variable c, the variable i, and a variable sum, respectively, in the function test. The function main does not use a variable, so that the function main is not subjected to the register allocation.

Then, the non-volatile register extracting unit 205 generates the non-volatile register information D5 based on the register allocation result by the register allocating unit 202 (S4). FIG. 8 is a diagram illustrating an example of the non-volatile register information D5. The non-volatile register information D5 indicates that $8 is used from among the registers defined to be used as the non-volatile register in the function sub and $9, $10, and $11 are used in the function test.

In some cases, the target processor includes a plurality of types of registers such as a core register and a coprocessor register and the register allocation is performed on these registers by the register allocating unit 202. The non-volatile register extracting unit 205 generates the non-volatile register information D5 on all of the non-volatile registers regardless of the type of the register.

Next, the assembler-code generating unit 203 generates the first assembler file D2 based on the register allocation result by the register allocating unit 202 (S5). In this example, the first assembler file D2 shown in FIG. 5B is generated.

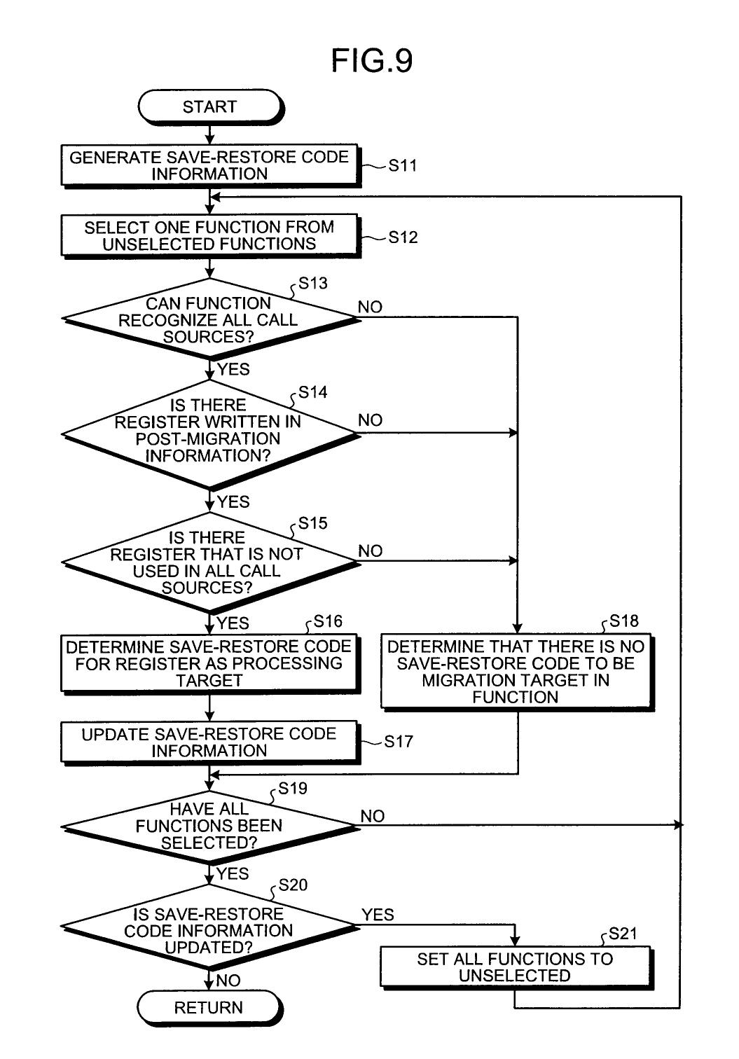

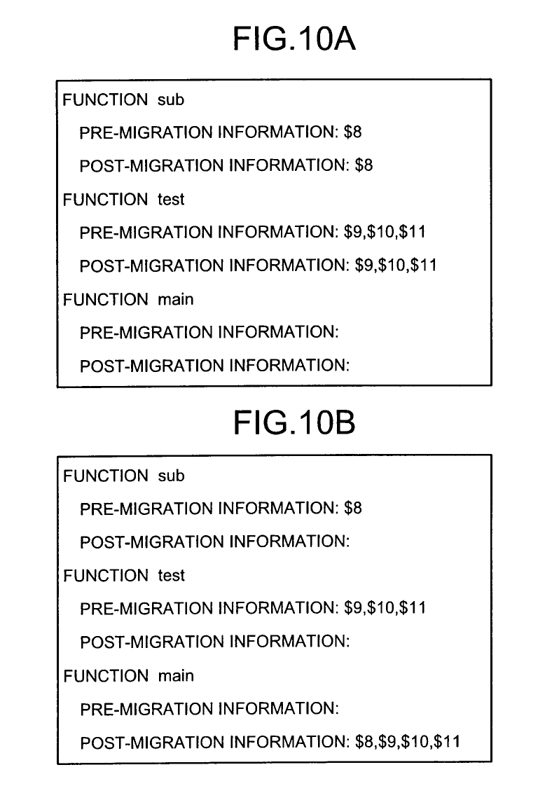

The save-restore code information generating unit 206 generates the save-restore code information D6 based on the function call information D4 and the non-volatile register information D5 (S6). FIG. 9 is a flowchart explaining an operation of generating the save-restore code information D6 by the save-restore code information generating unit 206. FIGS. 10A and 10B are diagrams illustrating examples of the save-restore code information D6 to be generated.

As shown in FIG. 9, the save-restore code information generating unit 206 generates the save-restore code information D6 as temporary information based on the non-volatile register information D5 (S11). The save-restore code information D6 as the temporary information immediately after generated is defined as the save-restore code information D6 in the initial state.

FIG. 10A is a diagram illustrating an example of the save-restore code information D6 in the initial state generated at S11. The save-restore code information D6 as the temporary information includes a description (pre-migration information) of the non-volatile register name to be the save-restore code generation target before the save-restore code migration processing for each function and a description (post-migration information) of the non-volatile register name for each function for indicating the temporary migration destination of the save-restore code after migration. The description of the non-volatile register name for each function indicates that the function that the non-volatile register belongs to in the description is the insertion position of the save-restore code for saving the non-volatile register content. In the save-restore code information D6 in the initial state, the post-migration information has a value same as the pre-migration information. Because the pre-migration information is the same as the non-volatile register information D5, the pre-migration information can be eliminated from the save-restore code information D6 as the temporary information and the compiling apparatus 200 can use the non-volatile register information D5 instead of the pre-migration information in the subsequent processing.

After S11, the save-restore code information generating unit 206 selects one function from the save-restore code information D6 (S12). Then, the save-restore code information generating unit 206 refers to the function call information D4 and determines whether the selected function is a function that can recognize all of the callers that call the function (S13). The function that can recognize all of the callers indicates that all of the callers that call the function are not a function called from other modules and are a function that is not called by the dynamic call.

When the function is a function that can recognize all of the callers (Yes at S13), the save-restore code information generating unit 206 refers to the post-migration information in the save-restore code information D6 and determines whether the register name is written in the post-migration information on the selected function (S14).

When the register name is written in the post-migration information on the selected function (Yes at S14), the save-restore code information generating unit 206 determines whether there is a register of which register name is not written in the pre-migration information on any caller among the callers that call the selected function, among the registers written in the post-migration information on the selected function (S15).

When there is a register of which register name is not written in the pre-migration information on any caller (Yes at S15), the save-restore code information generating unit 206 determines the save-restore code for this register as the migration target (S16), and updates the save-restore code information D6 as the temporary information (S17). Specifically, the save-restore code information generating unit 206 deletes the register name that is determined as the migration target from the post-migration information on the selected function and writes the register name in the post-migration information on all of the callers that call the selected function. When there is already a corresponding register name written in the write destination, the save-restore code information generating unit 206 does not write the register name in this write destination.

When the selected function is not a function that can recognize all of the callers (No at S13), the save-restore code information generating unit 206 determines that there is no save-restore code to be the migration target in the selected function (S18).

In the similar manner, when the register name is not written in the post-migration information (No at S14) or when there is no register of which register name is not written in the pre-migration information on any caller (No at S15), the system control proceeds to S18.

After S17 or S18, the save-restore code information generating unit 206 also determines whether all of the functions have been selected (S19). When there is an unselected function (No at S19), the system control proceeds to S12 and repeats S12 to S18 until there is no unselected function.

When all of the functions have already been selected (Yes at S19), the save-restore code information generating unit 206 determines whether the save-restore code information D6 as the temporary information is updated by the processing from S12 to S19 (S20). When the save-restore code information D6 is updated (Yes at S20), the save-restore code information generating unit 206 sets all of the functions to an unselected state (S21) and the system control proceeds to S12. When the save-restore code information D6 is not updated (No at S20), there is no save-restore code to be a new migration target any longer, so that the operation of the save-restore code information generating unit 206 is returned. In the first determination processing at S20, the save-restore code information generating unit 206 determines whether the save-restore code information D6 is updated from the initial state. In the second and subsequent determination processing at S20, the save-restore code information generating unit 206 determines whether the save-restore code information D6 as the temporary information is updated after the last determination processing at S20. FIG. 10B illustrates the save-restore code information D6 after the processing at S6.

After S6, the save-restore code migration processing unit 207 performs the save-restore code migration processing on the first assembler file D2 based on the generated save-restore code information D6 to generate the second assembler file D3 (S7). In the save-restore code migration processing, the non-volatile register that is written in the pre-migration information and is not written in the post-migration information is extracted for each function and the save-restore code for each function for protecting the content of the extracted non-volatile register is deleted from the entry-exit point of the function that is written in the pre-migration information, and the non-volatile register that is written in the post-migration information and is not written in the pre-migration information is extracted for each function and the save-restore code for protecting the content of the extracted non-volatile register is inserted into the entry-exit point of the function that is written in the post-migration information. For example, in the save-restore code information D6 shown in FIG. 10B, the save-restore code migration processing unit 207 deletes the save-restore code for $8 from the function sub and the save-restore codes for $9 to $11 from the function test and writes the save-restore codes for $8 to $11 in the function main. In other words, the save-restore code for $8 migrates from the function sub to the function main and the save-restore codes for $9 to $11 migrate from the function test to the function main. As the save-restore code migration processing, the save-restore code migration processing unit 207 can delete all of the save-restore codes for the non-volatile registers written in the pre-migration information and add all of the save-restore codes for the non-volatile registers written in the post-migration information.

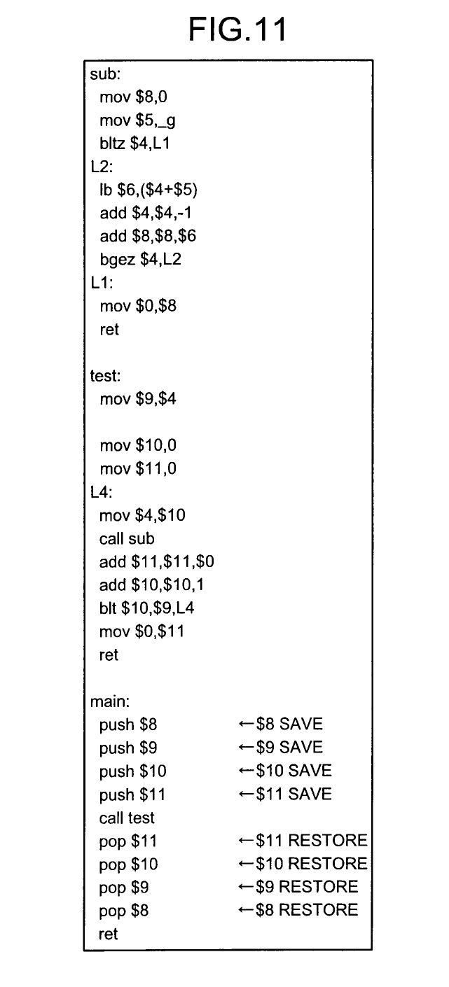

FIG. 11 is a diagram of an example of the second assembler code written in the generated second assembler file D3. It is found that the save-restore codes for the function sub and the function test written in an example of the first assembler code shown in FIG. 5B are migrated to the function main in the second assembler code shown in FIG. 11. In this second assembler code, the save-restore code for $8 that is executed every time the function test executes the loop processing is migrated to the function main, i.e., out of this loop processing, so that the number of executions of the save-restore code for $8 is reduced compared with the first assembler code.

Explanation is given for the case where the save-restore codes for the same non-volatile register migrate to the same caller from a plurality of the callees. FIG. 12-1A to FIG. 12-2D are diagrams for explaining specific examples in this case.

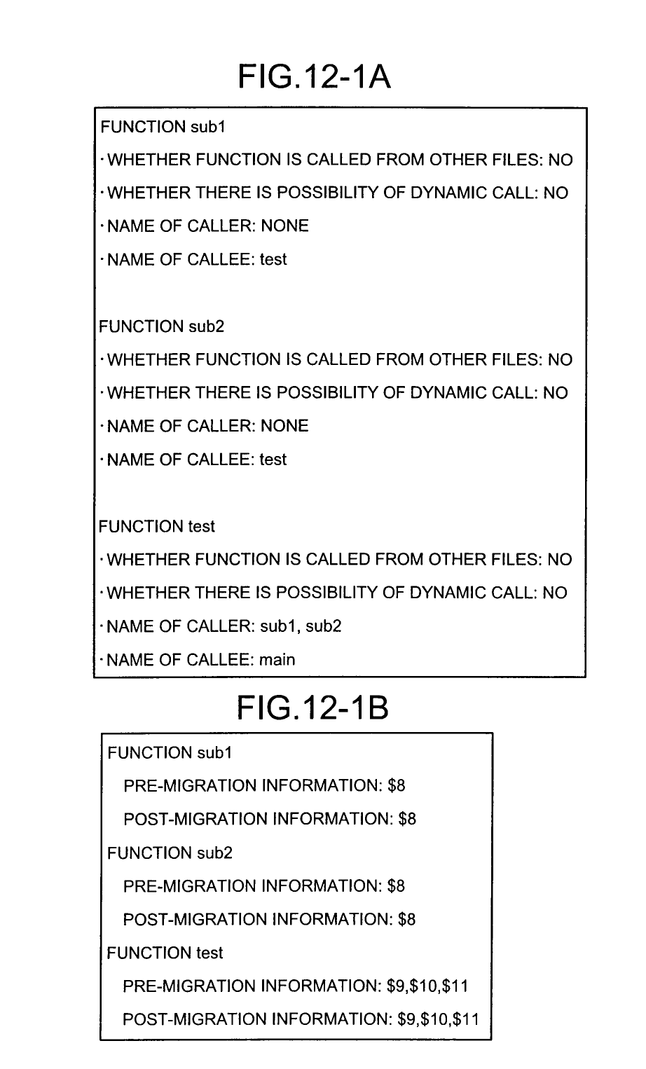

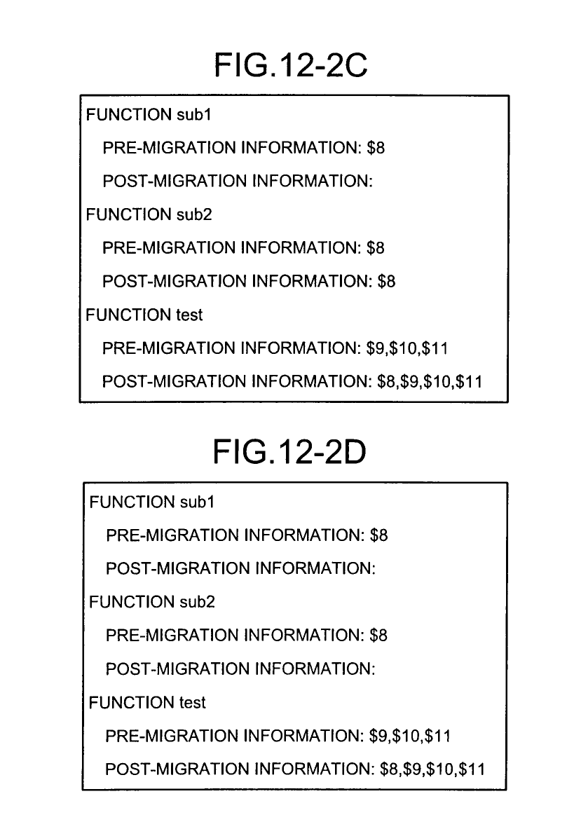

FIG. 12-1A is a diagram illustrating an example of the function call information D4. This function call information D4 indicates that the function test calls a function sub1 and a function sub2 and the function test is called from the function main (not shown). Moreover, this function call information D4 indicates that the function test, the function sub1, and the function sub2 are not a function called from other modules and are a function that is not called by the dynamic call.

FIG. 12-1B is a diagram illustrating an example of the save-restore code information D6 in the initial state.

When the function sub1 is selected at S12, the save-restore code information D6 shown in FIG. 12-1B is updated, and the save-restore code information D6 becomes a state in which $8 is deleted from the post-migration information on the function sub1 and $8 is added to the post-migration information on the function test (FIG. 12-2C). Then, when the system control proceeds to S12 again and the function sub2 is selected, the save-restore code information D6 shown in FIG. 12-2C is further updated, so that the save-restore code information D6 becomes a state in which $8 is deleted from the post-migration information on the function sub2 (FIG. 12-2D). Because $8 deleted from the function sub1 is already added to the post-migration information on the function test, $8 deleted from the post-migration information on the function sub2 is not added to the post-migration information on the function test.

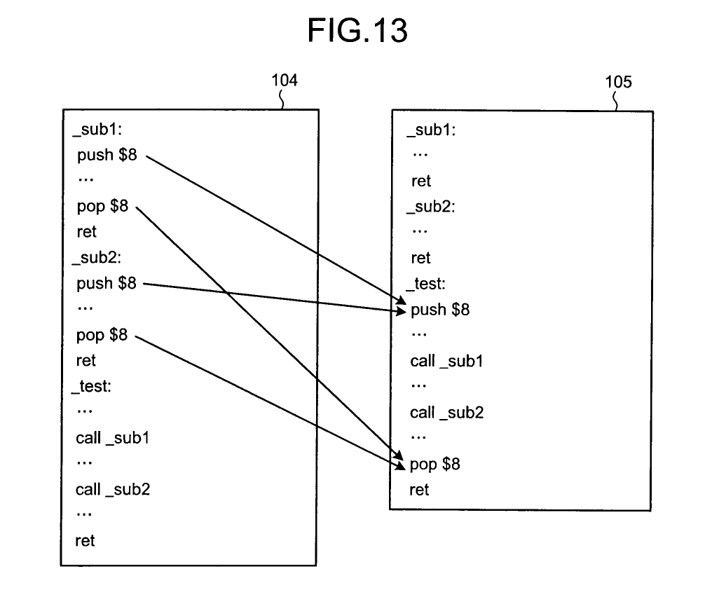

FIG. 13 is a diagram in which the first assembler code (FIG. 12-1B) is compared with the second assembler code (FIG. 12-2D). In a first assembler code 104, both of the function sub1 and the function sub2 include the save-restore code for $8 at the entry-exit point. On the contrary, in a second assembler code 105, the save-restore code for $8 is included at the entry-exit point of the function test. In other words, in the second assembler code 105, one save-restore code for $8 is reduced compared with the first assembler code 104.

In this manner, when the save-restore codes for the same non-volatile register migrate to the same caller from a plurality of the callees, the save-restore codes are controlled not to overlap in the migration destination, so that the code size of the assembler code can be reduced.

According to the technology disclosed in Japanese Patent Application Laid-open No. H11-272473, the number of executions of the save-restore code is reduced by deleting the save-restore code. However, for deleing the save-restore code, it is needed that the deletion of the save-restore code does not cause a problem on the operation of the program. In other words, the condition is required for deleting the save-restore code that the register is not used between the initial function of an application program and the function in which the save-restore code is deleted. On the contrary, in the first embodiment of the present invention, the save-restore code is only migrated from the callee to the caller, so that the value of the non-volatile register is saved as viewed from the upper function of the caller, and therefore the operation of the program is not affected. In other words, according to the first embodiment of the present invention, the condition for migrating the save-restore code is only that the register is not used in the caller, so that the assembler code in which the number of executions of the save-restore code is further reduced than the technology disclosed in Japanese Patent Application Laid-open No. H11-272473 can be generated by migrating the save-restore code even in the case where the save-restore code cannot be deleted by the technology disclosed in Japanese Patent Application Laid-open No. H11-272473.

In the first embodiment of the present invention, the non-volatile register information D5 on all of the registers is generated without distinguishing between the core register and the coprocessor register. For the processor in which the core register and the coprocessor register are distinguished, the processing using the coprocessor register more is performed in local functions and the processing using the core register without using the coprocessor register is performed in an upper function that calls the local functions in some cases. In such a case, the save-restore code for the coprocessor register in the local function can be often migrated to the upper function, so that the number of executions of the save-restore code can be reduced significantly.

As described above, according to the first embodiment of the present invention, the first assembler file D2 in which the save-restore code for protecting the non-volatile register content used is inserted into the entry-exit point of the function that uses the non-volatile register is generated from the source file D1, the function call information in which the call relation between the functions included in the source file D1 is written is generated based on the syntax analysis result output in the process of generating the first assembler file D2, the non-volatile register information D5 that is a list of the non-volatile register used in the function included in the source code for each function is generated based on the register allocation result output in the process of generating the first assembler file D2, the save-restore code information D6 that indicates the function as the insertion destination of the save-restore code after migration for each save-restore code is generated by performing the determination processing of determining whether the save-restore code can be migrated from the function into which the save-restore code is inserted to the function that is the call source of the function for each save-restore code based on the function call information D4 and the non-volatile register information D5, and the second assembler file D3 is generated by performing the save-restore code migration processing on the save-restore code written in the first assembler file D2 based on the save-restore code information. Therefore, the save-restore code inserted into the entry-exit point of the callee can be migrated to the entry-exit point of the caller, so that the assembler code in which the number of executions of saving the register content is reduced can be generated.

Moreover, the save-restore code information D6 as the temporary information that indicates the function as the temporary migration destination for each save-restore code is generated, the save-restore code information D6 as the temporary information is updated every time the determination processing is performed, and the save-restore code information D6 as the temporary information is set to the save-restore code information D6 for performing the save-restore code migration processing when the save-restore code information D6 as the temporary information becomes unchanged before and after the update, so that the assembler code in which the number of executions of the save-restore code is reduced as much as possible can be generated.

In the above explanation, explanation is given for the case where the push and pop instructions involving the reserving and releasing instructions of the stack area are set as the save-restore code; however, the save-restore code can be any instruction so long as the instruction is for saving/restoring the register content. For example, a pair of a load and store instruction and an add-subtract instruction of a stack pointer that does not involve the reserving and releasing instructions of the stack area can also be used as the save-restore code other than the push and pop instructions. Moreover, the program written in C is raised as an example of the source file D1; however, the description language of the source file D1 has a concept of the function other than C, so that the description language can be the high-level language that is converted into the assembler code by a compiler.

A user converts the second assembler file D3 into a relocatable file by using the assembler program for obtaining an execution file that is finally operated in the target processor. Then, the user integrates all of the relocatable files generated for respective files and performs an address resolution by using a link program thereby obtaining the execution file.

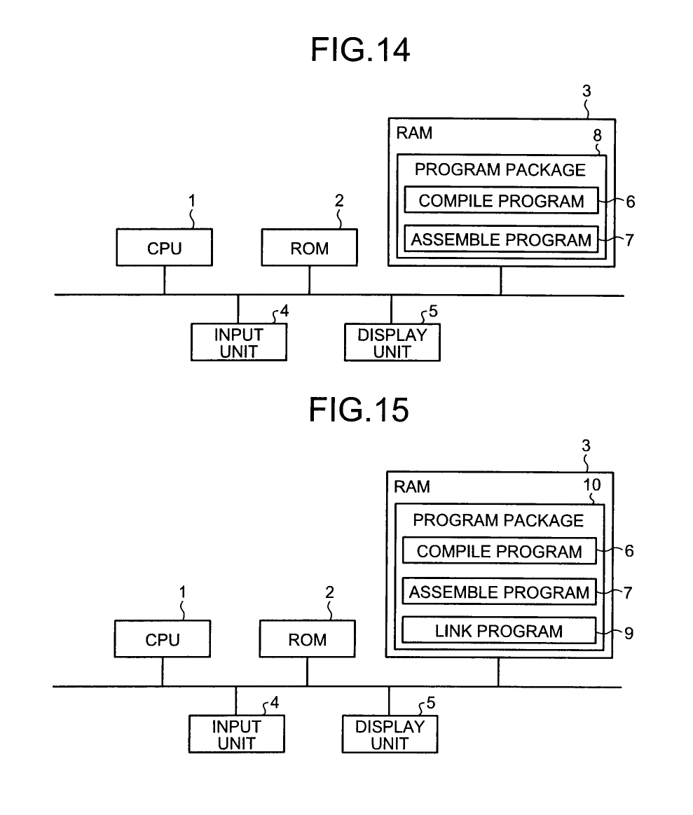

As shown in FIG. 14, the compile program 6 in the first embodiment can be provided as part of a program package 8 in which the compile program 6 is packaged with an assemble program 7 for converting the second assembler file D3 into the relocatable file. Moreover, as shown in FIG. 15, the compile program 6 in the first embodiment can be provided as part of a program package 10 in which the compile program 6 is packaged with the assemble program 7 and a link program 9 for integrating all of the relocatable files generated for respective files and performing the address resolution.

A second embodiment of the present invention is applied to a compiling and assembling apparatus that converts the source code into the relocatable file for each file.

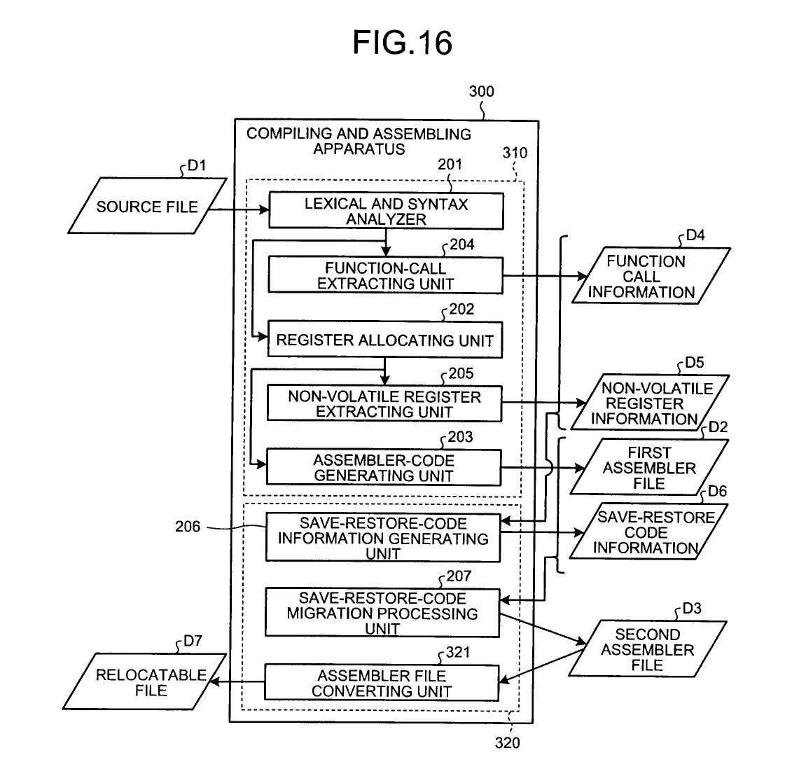

FIG. 16 is a configuration diagram of the compiling and assembling apparatus according to the second embodiment. Components that have a function similar to that in the first embodiment are given the same reference numerals as in the first embodiment and explanation thereof is omitted.

A compiling and assembling apparatus 300 includes a compiling unit 310 that generates the first assembler file D2, the function call information D4, and the non-volatile register information D5 from the input source file D1 and an assembling unit 320 that generates the second assembler file D3 based on the first assembler file D2, the function call information D4, and the non-volatile register information D5 and generates a relocatable file D7 from the generated second assembler file D3.

The compiling unit 310 includes the lexical and syntax analyzer 201 that performs the lexical syntax analysis on the source file D1, the function-call extracting unit 204 that generates the function call information D4 based on the analysis result by the lexical and syntax analyzer 201, the register allocating unit 202 that allocates the variable to the register based on the analysis result by the lexical and syntax analyzer 201, the non-volatile register extracting unit 205 that generates the non-volatile register information D5 based on the register allocation result by the register allocating unit 202, and the assembler-code generating unit 203 that generates the first assembler file D2 based on the register allocation result by the register allocating unit 202.

The assembling unit 320 includes the save-restore code information generating unit 206 that generates the save-restore code information D6 based on the function call information D4 and the non-volatile register information D5, the save-restore code migration processing unit 207 that performs the save-restore code migration processing on the first assembler file D2 based on the save-restore code information D6 and generates the second assembler file D3, and an assembler file converting unit 321 that generates the relocatable file D7 from the second assembler file D3.

The compiling and assembling apparatus 300 in the second embodiment is realized by a hardware configuration same as that shown in FIG. 14. However, in the compiling and assembling apparatus 300, the function-call extracting unit 204 and the non-volatile register extracting unit 205 are realized by the compile program 6 and the save-restore code information generating unit 206 and the save-restore code migration processing unit 207 are realized by the assemble program 7, among the function-call extracting unit 204, the non-volatile register extracting unit 205, the save-restore code information generating unit 206, and the save-restore code migration processing unit 207, which is different from the first embodiment.

In this manner, the first assembler file D2 is generated from the source file D1, and the save-restore code migration processing is performed on the generated first assembler file D2 to generate the second assembler file D3 that is the assembler file in which the number of executions of the save-restore code is reduced, so that the relocatable file D7 in which the number of executions of saving/restoring the non-volatile register content is reduced can be generated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A language processing apparatus comprising:
a first assembler file generating unit that allocates a variable included in a source program written in a single module to a register, generates an assembler code for each function, inserts a save-restore code for the register into an entry-exit point of a function that uses the register, and generates a first assembler program; and
a second assembler file generating unit that, when the register used in the function is not used in a caller, migrates the save-restore code for the register written in the first assembler file to an entry-exit point of the caller, and generates a second assembler program.

2. The language processing apparatus according to claim 1, wherein
the first assembler file generating unit includes
a lexical and syntax analyzing unit that performs a lexical and syntax analysis on the source program,
a register allocating unit that allocates the register to the variable included in the source program based on an analysis result by the lexical and syntax analyzing unit, and
a first assembler code generating unit that generates the first assembler program in which a save-restore code for protecting content of a non-volatile register in which a value does not change in the function included in the source program is inserted into an entry-exit point of a function that uses the non-volatile register from the source program based on an allocation result by the register allocating unit, and
the second assembler file generating unit includes
a function-call extracting unit that generates function call information in which a call relation between functions included in the source program is written based on the analysis result by the lexical and syntax analyzing unit,
a non-volatile register extracting unit that generates non-volatile register information on the non-volatile register for each function based on the allocation result by the register allocating unit,
a save-restore code information generating unit that determines whether the save-restore code is capable of being migrated from the function into which the save-restore code is inserted to a function as a call source of the function based on the function call information and the non-volatile register information and generates save-restore code information that indicates a function as a migration destination of the save-restore code, and
a migration processing unit that migrates the save-restore code written in the first assembler program based on the non-volatile register information and the save-restore code information and generates the second assembler program.

3. The language processing apparatus according to claim 2, wherein the save-restore code information generating unit generates temporary information that indicates a function as a temporary migration destination for each save-restore code, repeatedly performs unit processing of determining based on the temporary information and reflecting in the temporary information on every execution result of the determination, and sets temporary information that becomes unchanged before and after the unit processing as the save-restore code information when the temporary information becomes unchanged before and after the unit processing.

4. The language processing apparatus according to claim 3, wherein the save-restore code information generating unit recognizes all of functions that call the function as the temporary migration destination indicated in the temporary information based on the function call information and determines whether there is a function into which same save-restore code is inserted by the first assembler code generating unit among recognized functions based on the non-volatile register information, decides that the non-volatile register is capable of being migrated when there is no function into which the same save-restore code is inserted, and decides that the non-volatile register is not capable of being migrated when there is the function into which the same save-restore code is inserted, for each save-restore code.

5. The language processing apparatus according to claim 2, wherein
the function call information further includes information that indicates whether the function is a function called by a dynamic call and whether the function is a function called only from a function in the module, for each function, and
the save-restore code information generating unit sets a save-restore code included in a function that is not the function called by the dynamic call and is the function called only from the function in the module as a target for performing determination.

6. The language processing apparatus according to claim 3, wherein the migration processing unit deletes a save-restore code for protecting content of a non-volatile register that is written in the non-volatile register information and is not written in the save-restore code information from the first assembler program, and inserts a save-restore code for protecting content of a non-volatile register that is not written in the non-volatile register information and is written in the save-restore code information into the first assembler program.

7. The language processing apparatus according to claim 1, further comprising a relocatable program generating unit that converts the second assembler program into a relocatable program.

8. A language processing method comprising:
performing a lexical and syntax analysis on a source program written in a single module;
generating function call information in which a call relation between functions included in the source program is written based on an execution result of the lexical and syntax analysis;
allocating a register to a variable included in the source program based on the execution result of the lexical and syntax analysis;
generating non-volatile register information on a non-volatile register in which a value does not change in the function included in the source program for each function based on an allocation result of the variable;
generating a first assembler program in which a save-restore code for protecting content of the non-volatile register is inserted into an entry-exit point of a function that uses the non-volatile register from the source program based on the allocation result of the variable;
determining whether the save-restore code is capable of being migrated from the function into which the save-restore code is inserted to a function as a call source of the function based on the function call information and the non-volatile register information and generating save-restore code information that indicates a function as a migration destination of the save-restore code; and
migrating the save-restore code written in the first assembler program based on the non-volatile register information and the save-restore code information and generating a second assembler program.

9. The language processing method according to claim 8, wherein
the generating the save-restore code information includes
generating temporary information that indicates a function as a temporary migration destination for each save-restore code,
performing repeatedly unit processing of determining based on the temporary information and reflecting in the temporary information on every execution result of the determination, and
setting temporary information that becomes unchanged before and after the unit processing as the save-restore code information when the temporary information becomes unchanged before and after the unit processing.

10. The language processing method according to claim 9, wherein
the determining includes, for each save-restore code,
recognizing all of functions that call the function as the temporary migration destination indicated in the temporary information based on the function call information and determining whether there is a function into which same save-restore code is inserted at the generating the first assembler code among recognized functions based on the non-volatile register information,
deciding that the non-volatile register is capable of being migrated when there is no function into which the same save-restore code is inserted, and
deciding that the non-volatile register is not capable of being migrated when there is the function into which the same save-restore code is inserted.

11. The language processing method according to claim 8, wherein
the function call information further includes information that indicates whether the function is a function called by a dynamic call and whether the function is a function called only from a function in the module, for each function, and
a target for performing the determining is a save-restore code included in a function that is not the function called by the dynamic call and is the function called only from the function in the module.

12. The language processing method according to claim 9, wherein the temporary information is a list of a non-volatile register of which content is saved by inserted save-restore code for each function.

13. The language processing method according to claim 12, wherein
the migrating the save-restore code written in the first assembler program includes
deleting a save-restore code for protecting content of a non-volatile register that is written in the non-volatile register information and is not written in the save-restore code information from the first assembler program, and
inserting a save-restore code for protecting content of a non-volatile register that is not written in the non-volatile register information and is written in the save-restore code information into the first assembler program.

14. The language processing method according to claim 8, further comprising converting the second assembler program into a relocatable program.

15. A computer program product including a plurality of instructions executable on a computer, wherein the instructions, when executed by the computer, cause the computer to perform:
performing a lexical and syntax analysis on a source program written in a single module;
generating function call information in which a call relation between functions included in the source program is written based on an execution result of the lexical and syntax analysis;
allocating a register to a variable included in the source program based on the execution result of the lexical and syntax analysis;
generating non-volatile register information on a non-volatile register in which a value does not change in the function included in the source program for each function based on an allocation result of the variable;
generating a first assembler program in which a save-restore code for protecting content of the non-volatile register is inserted into an entry-exit point of a function that uses the non-volatile register from the source program based on the allocation result of the variable;
determining whether the save-restore code is capable of being migrated from the function into which the save-restore code is inserted to a function as a call source of the function based on the function call information and the non-volatile register information and generating save-restore code information that indicates a function as a migration destination of the save-restore code; and
migrating the save-restore code written in the first assembler program based on the non-volatile register information and the save-restore code information and generating a second assembler program.

16. The computer program product according to claim 15, wherein
the generating the save-restore code information includes
generating temporary information that indicates a function as a temporary migration destination for each save-restore code,
performing repeatedly unit processing of determining based on the temporary information and reflecting in the temporary information on every execution result of the determination, and
setting temporary information that becomes unchanged before and after the unit processing as the save-restore code information when the temporary information becomes unchanged before and after the unit processing.

17. The computer program product according to claim 16, wherein
the determining includes, for each save-restore code,
recognizing all of functions that call the function as the temporary migration destination indicated in the temporary information based on the function call information and determining whether there is a function into which same save-restore code is inserted at the generating the first assembler code among recognized functions based on the non-volatile register information,
deciding that the non-volatile register is capable of being migrated when there is no function into which the same save-restore code is inserted, and
deciding that the non-volatile register is not capable of being migrated when there is the function into which the same save-restore code is inserted.

18. The computer program product according to claim 15, wherein
the function call information further includes information that indicates whether the function is a function called by a dynamic call and whether the function is a function called only from a function in the module, for each function, and
a target for performing the determining is a save-restore code included in a function that is not the function called by the dynamic call and is the function called only from the function in the module.

19. The computer program product according to claim 16, wherein the temporary information is a list of a non-volatile register of which content is saved by inserted save-restore code for each function.

20. The computer program product according to claim 19, wherein
the migrating the save-restore code written in the first assembler program includes
deleting a save-restore code for protecting content of a non-volatile register that is written in the non-volatile register information and is not written in the save-restore code information from the first assembler program, and
inserting a save-restore code for protecting content of a non-volatile register that is not written in the non-volatile register information and is written in the save-restore code information into the first assembler program.
